(19) United States
(12) Patent Application Publication
(10) Pub. No.: US 2019/0351951 A1
(43) Pub. Date: Nov. 21, 2019

(54) Formed Plate or Sheet Product for Vehicles

(71) Applicant: Don NICHOLSON, Duarte, CA (US)

(72) Inventor: Don NICHOLSON, Duarte, CA (US)

(21) Appl. No.: 15/985,341

(22) Filed: May 21, 2018

(51) Int. Cl. B62D 27/02; B62D 29/00; B62D 37/02; B62D 21/15

(52) U.S. Cl. CPC B62D 27/023; B62D 21/155; B62D 37/02; B62D 29/001

(57) ABSTRACT

Invention is a formed plate or sheet product which attaches to the underside of a vehicle, operating in shear with some bending. The formed plate or sheet product connects the Front Suspension Assembly, the Rear Suspension Assembly, and the Structural Body of a vehicle of unitary construction or frame-on-body construction or any combination thereof. The purpose the invention is to a) increase torsional rigidity of a vehicle and b) reduce torsional and translational compliance between the front suspension assembly, the rear suspension assembly, and the structural body. The invention forms a monolithic component, attaching to the vehicle using one or more of the auto manufacturer's mounting points.

### BACKGROUND OF THE INVENTION

The present invention relates to a vehicle having a formed plate/sheet product.

There are several underparts in a vehicle, and they must be anchored somewhere in order to realize stable and proper operation of the vehicle.

Many conventional ways, methods, and Structural Shape Products have been used in the automobile industry for solving various problems arising from flexible component attachment. Structural Shape Products include tubes, beams, bars, channels or other similar elements. Structural Shape Products have members operating in tension and compression with some bending.

Still, however, there are problems to solve and situations to deal with in order to facilitate the optimal operation of vehicles.

Accordingly, a need for a vehicle to have a Formed Plate or Sheet Product has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a Formed Plate/Sheet Product for vehicles to increase vehicle rigidity.

An aspect of the invention provides a vehicle comprising a Structural Body, Front Suspension Assembly, Rear Suspension Assembly and adding a Formed Plate/Sheet Product.

The Structural Body is the primary structure of the vehicle, and may be comprised of unitary construction or frame-on-body construction or any combination thereof.

The Front Suspension Assembly includes all wheels, brakes, suspension arms, drive components and all associated components. The Front Suspension Assembly may be attached directly to the Structural Body or through an intermediate structural assembly known as a subassembly.

The Rear Suspension Assembly includes all wheels, brakes, suspension arms, drive components and all associated components. The Rear Suspension Assembly may be attached directly to the Structural Body or through an intermediate structural assembly known as a subassembly.

The Formed Plate/Sheet Product proposed in this application includes products which are planar construction with thickness significantly smaller than length or width. It may be constructed of rolled metals, molded composites, or other forms including honeycombed structures, as a largely planar product operating in shear. The Formed Plate/Sheet Product serves to connect all permutations of 1) Structural body, 2) Structural Body to Front Suspension Assembly, 3) Structural Body to Rear Suspension Assembly, 4) Structural Body to Front Suspension Assembly and Rear Suspension Assembly, 5) Front Suspension Assembly to Rear Suspension Assembly.

The Formed Plate/Sheet Product can be a single structure substantially covering the entire undercarriage between the Front Suspension Assembly and the Rear Suspension Assembly.

The Formed Plate/Sheet Product may comprise a front end portion, a rear end portion, and a middle portion provided between the front end portion and the rear end portion.

The front end portion of the Formed Plate/Sheet Product can be attached to the Front Suspension Assembly and the rear end portion of the shear plate can be attached to the Rear Suspension Assembly, and the middle portion can be configured for covering the undercarriage.

The Formed Plate/Sheet Product may comprise a single monolithic plate or multiple plates, depending on the vehicle.

In certain embodiments of the invention, the Formed Plate/Sheet Product may comprise one or more protruding arm plate portions.

The Formed Plate/Sheet Product may further compose one or more through-holes.

Another aspect of the invention provides a vehicle of unibody construction, which comprises a Front Suspension Assembly, a Rear Suspension Assembly, a Structural Body, and a Formed Plate/Sheet Product as in the above embodiment. Also, the Formed Plate/Sheet Product is attached to the Front Suspension Assembly and the Rear Suspension Assembly, and all other inventive features of the above applies to this embodiment.

The Formed Plate/Sheet Product can be attached to the Structural Body, Front Suspension Assembly and the Rear Suspension Assembly using one or more auto manufacturer's mounting points.

The advantages of the present invention are: (1) the vehicle according to the invention will have a rigid structure; and (2) the vehicle having an under-chassis strengthening structure (Formed Plate/Sheet Product) can be realized by a simple and inventive structure.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a bottom view showing a vehicle 100 with the Structural Body 10, Front Suspension Assembly 20, and Rear Suspension Assembly 30;

FIG. 2 is a bottom view showing a vehicle 100 with the Structural Body 10, Front Suspension Assembly 20, and Rear Suspension Assembly 30, with a Formed Plate/Sheet Product 40 in place, attaching the Structural Body 10, Front Suspension Assembly 20, and Rear Suspension Assembly 30;

FIG. 3 is a perspective bottom view of FIG. 1 showing a vehicle 100 with the Structural Body 10, Front Suspension Assembly 20, and Rear Suspension Assembly 30;

FIG. 4 is a perspective bottom view of FIG. 2 showing vehicle 100 with the Structural Body 10, Front Suspension Assembly 20, and Rear Suspension Assembly 30, with a Formed Plate/Sheet Product 40 in place, attaching the Structural Body 10, Front Suspension Assembly 20, and Rear Suspension Assembly 30 using through holes 60 in the Plate/Sheet Product for attachment;

FIG. 5 is an exploded perspective bottom view of FIG. 4 showing vehicle 100 with the Structural Body 10, Front Suspension Assembly 20, and Rear Suspension Assembly 30, with a Formed Plate/Sheet Product assembly 40, detailing a front section 42 and rear section 44 of the Formed Plate/Sheet Product 40;

FIG. 6 is a plan view of the Formed Plate/Sheet Product Assembly 40 with front section 42, rear section 44, and protruding shapes 41.

### DETAILED DESCRIPTION EMBODIMENTS OF THE INVENTION

Referring to the figures, the embodiments of the invention are described in detail.

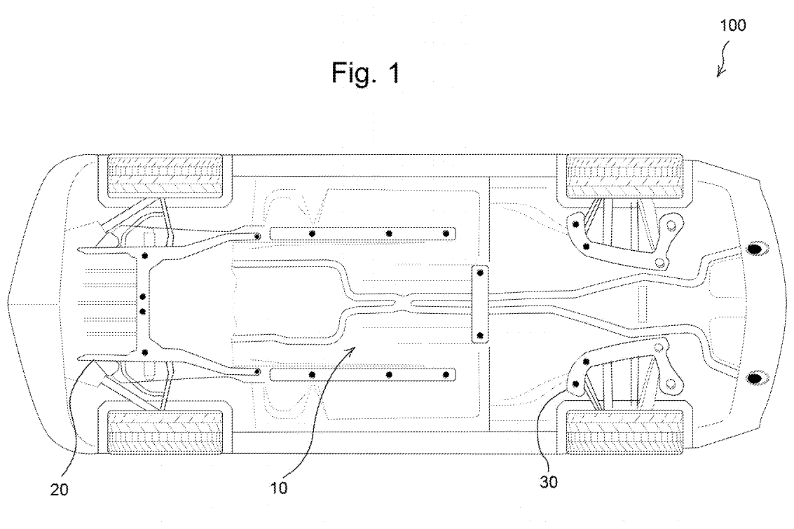

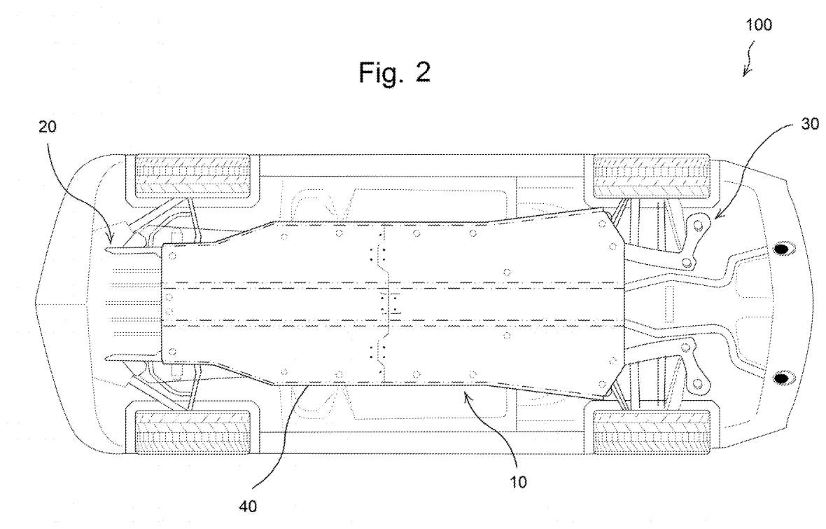

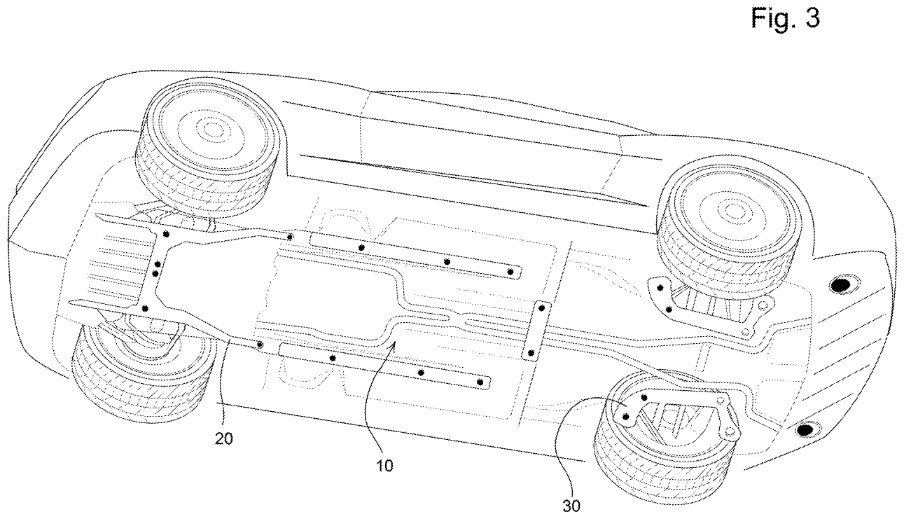

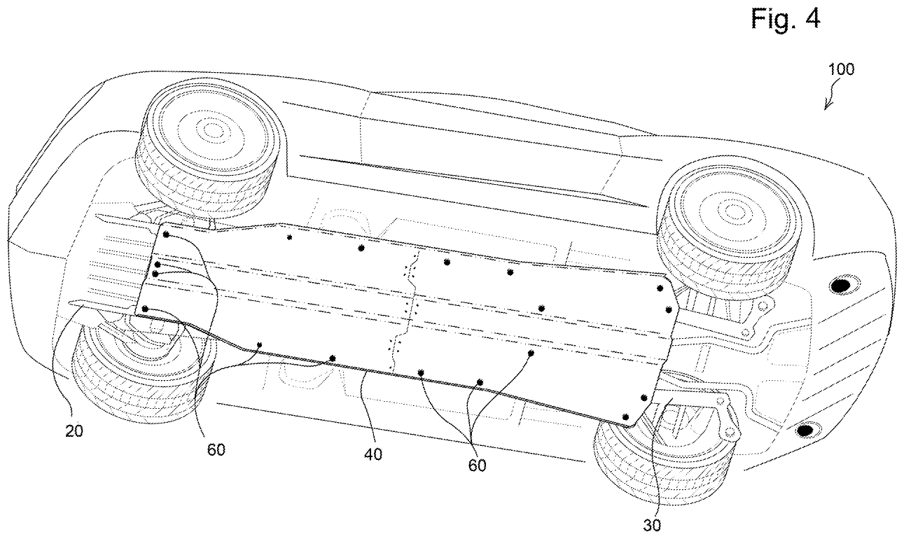

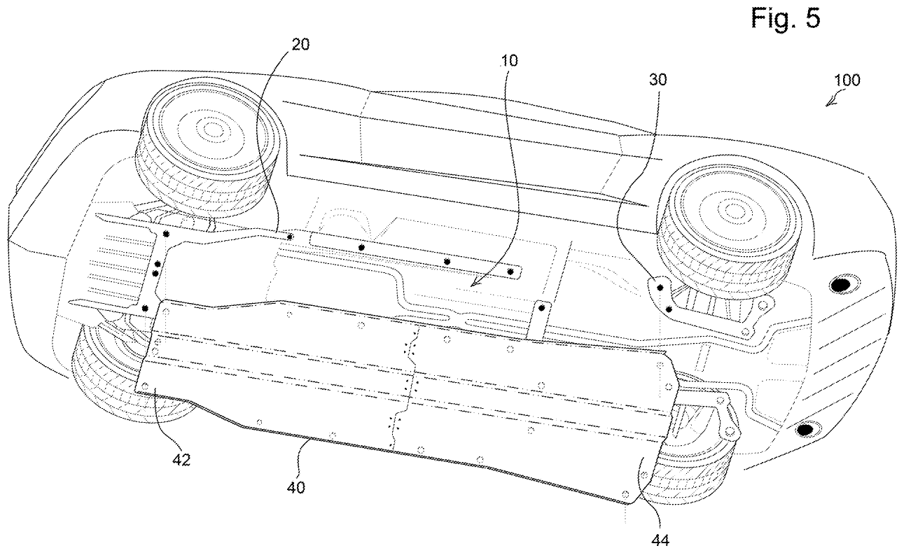

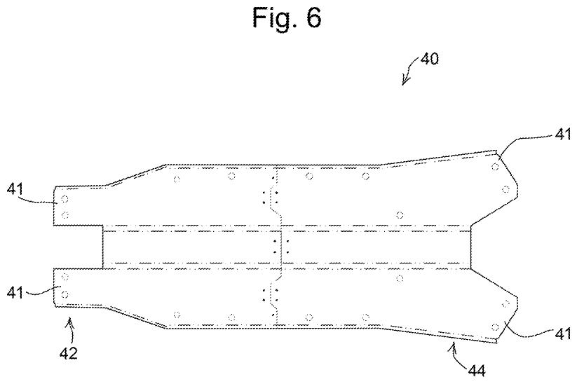

FIGS. 1 and 3 show bottom views of a vehicle in standard form, with no Formed Plate/Sheet Product. FIGS. 2 and 4 show bottom views of the vehicle with a Formed Plate/Sheet Product in place. In FIG. 5, the shear plate is removed and positioned below the lower portion of the vehicle for perspective. FIG. 6 show variations of the shape of the Formed Plate/Sheet Product 40 according to another embodiments of the invention.

An aspect of the invention provides a vehicle 100 comprising a Structural Body 10, a Front Suspension Assembly 20, a Rear Suspension Assembly 30, and a Formed Plate/Sheet Product 40.

The Front Suspension Assembly 20 is disposed in a front portion of the vehicle 100, and the Rear Suspension Assembly 30 is disposed in a rear portion of the vehicle 100.

The Front Suspension Assembly 20 and Rear Suspension Assembly 30 are attached to the Structural Body 10.

The Formed Plate/Sheet Product 40 is disposed under the lower portion of the vehicle 100, and may be attached to the Front Suspension Assembly 20, Structural Body 10 and the Rear Suspension Assembly 30.

In certain embodiments of the invention, the Structural Plate/Sheet Product 40 may be attached to either/or the Front Suspension Assembly 20, Rear Suspension Assembly 30, and Structural Body 10.

The Formed Plate/Sheet Product 40 can be a single structure substantially covering the entire underside of the vehicle 100.

The Formed Plate/Sheet Product 40 may comprise a front end portion 42, a rear end portion 44, and a connector between the front end portion 42 and the rear end portion 44.

The Formed Plate/Sheet Product 40 may comprise a single monolithic plate.

In certain embodiments of the invention, the Formed Plate/Sheet Product 40 may comprise one or more protruding arm plate portions 41 as shown in FIG. 6.

The one or more protruding arm plate portions 41 can be attached to the Front Suspension Assembly 20, the Rear Suspension Assembly 30, or the Structural Body 10 depending on vehicle application.

The Formed Plate/Sheet Product 40 may further compose one or more through holes 60 as shown in FIG. 4.

The Formed Plate/Sheet Product 40 can be attached to the Front Suspension Assembly 20, Rear Suspension Assembly 30, or Structural Body 10 using one or more auto manufacturer's mounting points using through-holes 60 as shown in FIG. 4.

One of the inventive features is that the Formed Plate/Sheet Product 40 forms a single monolithic rigid piece and that it performs functions of anchoring the Front Suspension Assembly 20 and Rear Suspension Assembly 30 to the Structural Body 10 securely.

The exact shape of the Formed Plate/Sheet Product 40 can be varied according to the design conditions and the shapes of the neighboring portions of the vehicle 100.

Likewise, the Formed Plate/Sheet Product 40 can have irregular boundaries, and sometimes have one or more through-holes 60 across the surface thereof.

Also, the shear plate 50 is attached to the front subframe 10 and the rear subframe 20, and further all other inventive features of the above applies to this embodiment.

The unibody construction is known as unitary construction or unit body, or Body Frame Integral construction. Most vehicles are designed and built with unibody construction, which provides a certain amount of structural integrity and strength, but has compromises which this invention addresses.

### Definitions

Structural Body is the primary structure of the vehicle, and may be comprised of unitary construction or frame-on-body construction or any combination thereof.

Front Suspension Assembly includes all wheels, brakes, suspension arms, drive components and all associated components. The Front Suspension Assembly may be attached directly to the Structural Body or through an intermediate structural assembly known as a subassembly.

Rear Suspension Assembly includes all wheels, brakes, suspension arms, drive components and all associated components. The Rear Suspension Assembly may be attached directly to the Structural Body or through an intermediate structural assembly known as a subassembly.

Structural Shape Products includes tubes, beams, bars, channels or other similar elements.

Formed Plate/Sheet Product includes products which are planar construction with thickness significantly smaller than length or width. May be constructed of rolled metals, molded composites, or other forms including honeycombed structures, as a largely planar product operating in shear.

Formed Plate/Sheet Product serves to connect all permutations of 1) Structural body, 2) Structural Body to Front Suspension Assembly, 3) Structural Body to Rear Suspension Assembly, 4) Structural Body to Front Suspension Assembly and Rear Suspension Assembly, 5) Front Suspension Assembly to Rear Suspension Assembly.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A vehicle comprising:
a Front Suspension Assembly disposed in the front portion of the vehicle;
a Rear Suspension Assembly disposed in the rear portion of the vehicle;
a Structural Body to which the Front Suspension Assembly and Rear Suspension Assembly are attached;
a Formed Plate/Sheet Product disposed under the lower portion of the vehicle,
wherein the Formed Plate/Sheet Product is attached to the Structural Body, Front Suspension Assembly, and Rear Suspension Assembly.

2. The vehicle of claim 1, wherein the Formed Plate/Sheet Product is also attached to the vehicle.

3. The vehicle of claim 2, wherein the Formed Plate/Sheet Product is a single structure substantially covering the entire undercarriage between the Front Suspension Assembly and the Rear Suspension Assembly.

4. The vehicle of claim 2, wherein the Formed Plate/Sheet Product comprises a front end portion, a rear end portion, and a middle portion connector provided between the front end portion and the rear end portion.

5. The vehicle of claim 4, wherein the front end portion of the Formed Plate/Sheet Product is attached to the Front Suspension Assembly and the rear end portion of the Formed Plate/Sheet Product is attached to the Rear Suspension Assembly, while also attaching to the Structural Body.

6. The vehicle of claim 5, wherein the Formed Plate/Sheet Product comprises a single monolithic plate.

7. The vehicle of claim 5, wherein the Formed Plate/Sheet Product comprises one or more protruding arm plate portions.

8. The vehicle of claim 7, wherein the one or more protruding arm plate portions may attach to the Front Suspension Assembly, the Rear Suspension Assembly, and the Structural Body.

9. The vehicle of claim 7, wherein the Formed Plate/Sheet Product further composes one or more through-holes.

10. The vehicle of claim 1, wherein the Formed Plate/Sheet Product is attached to the Front Suspension Assembly, Rear Suspension Assembly, and Structural Body using one or more auto manufacturer's mounting points.

11. A vehicle of unibody construction having a separate Structural Body, Front Suspension Assembly and Rear Suspension Assembly, the vehicle comprising:
the Front Suspension Assembly disposed in a front portion of the vehicle;
the Rear Suspension Assembly disposed in a rear portion of the vehicle;
a Structural Body to which both the Front Suspension Assembly and Rear Suspension Assembly are attached;
a Formed Plate/Sheet Product disposed under the lower portion of the vehicle,
wherein the Formed Plate/Sheet Product is attached to the Structural Body, Front Suspension Assembly, and Rear Suspension Assembly.

12. The vehicle of claim 11, wherein the Formed Plate/Sheet Product is a single structure substantially covering the entire undercarriage between the Front Suspension Assembly and the Rear Suspension Assembly.

13. The vehicle of claim 12, wherein the Formed Plate/Sheet Product comprises a front end portion, a rear end portion, and a middle connection portion provided between the front end portion and the rear end portion.

14. The vehicle of claim 13, wherein the front end portion of the Formed Plate/Sheet Product is attached to the Front Suspension Assembly and the rear end portion of the Formed Plate/Sheet Product is attached to the Rear Suspension Assembly.

15. The vehicle of claim 14, wherein the Formed Plate/Sheet Product comprises a single monolithic plate.

16. The vehicle of claim 15, wherein the Formed Plate/Sheet Product comprises one or more protruding arm plate portions.

17. The vehicle of claim 16, wherein the one or more protruding arm plate portions are attached to the Front Suspension Assembly, the Rear Suspension Assembly, and the Structural Body.

18. The vehicle of claim 17, wherein the Formed Plate/Sheet Product further composes one or more through holes.

19. The vehicle of claim 11, wherein the Formed Plate/Sheet Product is attached to the Front Suspension Assembly, the Rear Suspension Assembly, and the Structural Body using one or more auto manufacturer's mounting points.
